(19) United States
(12) Patent Application Publication
(10) Pub. No.: US 2021/0101178 A1
(43) Pub. Date: Apr. 8, 2021

(54) Electrical Tuning of Focal Size with Single-Element Planar Focused Ultrasonic Transducer

(71) Applicant: UNIVERSITY OF SOUTHERN CALIFORNIA, LOS ANGELES, CA (US)

(72) Inventors: Eun Sok KIM, Rancho Palos Verde, CA (US); Yongkui TANG, Pasadena, CA (US)

(21) Appl. No.: 17/065,039

(22) Filed: Oct. 7, 2020

Related U.S. Application Data
(60) Provisional application No. 62/911,617, filed on Oct. 7, 2019.

(51) Int. Cl. B06B 1/06; G02B 3/08

(52) U.S. Cl. CPC B06B 1/0651; G02B 3/08; B06B 1/0625

(57) ABSTRACT

This document describes a single-element planar focused ultrasonic transducer with electrically tunable focal size (focal diameter in the focal plane), through modifying the design of a self-focusing acoustic transducer (SFAT). The transducer is built on a 1-mm-thick lead zirconate titanate (PZT) with (1) Fresnel acoustic lens formed with annular rings of air cavities on the top and (2) patterned annular ring electrodes on the bottom. By controlling the number of Fresnel rings being driven from the center, we were able to tune the focal size between 371 and 866 μm, while keeping the focal length at 6 mm, with 2.32 MHz pulsed ultrasound. When tested as a droplet ejector, the transducer ejected water droplets with diameter between 294 and 560 μm (between 13.3 and 92.0 nL in volume), depending on which set of electrodes are actuated.

### CROSS-REFERENCE TO RELATED APPLICATIONS

This application claims the benefit of U.S. provisional application Ser. No. 62/911,617 filed Oct. 7, 2019, the disclosure of which is hereby incorporated in its entirety by reference herein.

### STATEMENT REGARDING FEDERALLY SPONSORED RESEARCH OR DEVELOPMENT

The invention was made with Government support under Contract No. R21EB022932 awarded by the National Institutes of Health. The Government has certain rights to the invention.

### TECHNICAL FIELD

In at least one aspect, the present invention is related to ultrasonic transducers.

### BACKGROUND

Focused ultrasound is a powerful tool used in a wide range of fields including acoustic trapping [1], droplet ejection [2], neurostimulation [3], and cancer therapeutics [4]. Focusing is usually achieved through making the piezoelectric transducer into a curved shape or placing a lens on top of a planar transducer, and when the focal size needs to be varied, the lens or the whole transducer has to be physically changed.

Electrical turning of focal diameter can be obtained with ultrasonic phased array transducer (or simply termed as phased array) by applying different phase delays on the array elements to change the focusing characteristics. However, phased arrays require complicated control circuits and many bulky power amplifiers if high intensity is needed. Also, phased array suffers from cross-talk between adjacent array elements and grating lobes, especially when frequency is high.

Accordingly, there is a need for improved ultrasonic transducer designs with reduced cross-talking between adjacent array elements.

### SUMMARY

In at least one aspect, an inexpensive single-element focused ultrasonic transducer with electrical tunability of the focal size is provided. This ultrasonic transducer is a new design obtained by modifying our previously-demonstrated self-focusing acoustic transducers (SFAT) [5], and the experimentally-confirmed electrical tunability is obtained through a combination of (1) a Fresnel annual-ring air-cavity acoustic lens on the top of and (2) annual-ring patterned electrodes on the bottom of a piezoelectric substrate, respectively. Further shown is its application potential as a nozzle-less, heatless droplet ejector to eject sub-mm-sized liquid droplets whose size can be electrically varied.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIGS. 1A, 1B, and 1C. (A) Cross-sectional-view schematic of the transducer with electrically tunable focal size, showing how the Fresnel annular-ring air-cavity reflector lens prevents destructively-interfering waves from reaching the focal zone; (B) top view of the transducer, showing white annular-ring areas that represent air-cavities that block acoustic waves; (C) bottom view of the transducer, showing the bottom electrodes that are patterned into six annular rings, so that the corresponding Fresnel rings on the top side can be individually selected for actuation.

FIGS. 2A and 2B. Cross-sectional-view schematic of the transducer, showing how the focal size changes with (A) 4 Fresnel rings and (B) 2 Fresnel rings actuated from center. With more Fresnel rings actuated from center, the focal size will be smaller (and vice versa).

FIGS. 3A, 3B, 3C, 3D, 3E, and 3F. Fabrication process for the transducer: (A) pattern electrodes on both sides of PZT; (B) spin-coat and pattern photoresist as sacrificial layer for air cavity rings; (C) deposit Parylene; (D) pattern release holes on Parylene; (E) remove photoresist with acetone, rinse and air dry; (F) deposit Parylene to seal the air cavities.

FIGS. 4A and 4B. Photos of (A) top side of the transducer, showing eight Fresnel rings (dark grey ring or circle areas) separated by eight air-cavity rings (light grey ring areas) with filled release holes (at 0°, 90°, 180°, 270° positions of each ring) on a circular nickel electrode; and (B) bottom side of the transducer, showing six electrode rings with wires soldered for individual electrical accesses.

FIG. 5. Measurement set-up for measuring acoustic pressure with hydrophone.

FIGS. 6A and 6B. Measured normalized acoustic pressure: (A) along the central vertical axis with 8 rings being actuated, showing focal length of 6 mm and (B) along a central lateral axis at the focal plane with different numbers of rings actuated from center, showing varied focal sizes (diameters).

FIG. 7. Measurement set-up for capturing photos of droplet ejection.

FIGS. 8A, 8B, 8C, 8D, 8E, and 8F. Photos showing sub-mm-sized water droplets of different diameters ejected by the focal-size-tunable transducer, when (A) 2 rings, (B) 3 rings, (C) 4 rings, (D) 5 rings, (E) 6 rings, (F) 8 rings are actuated from the center. The arcs at the bottom of each photo are part of air-cavity rings on the top of the transducer and the red area is from LED (light-emitting diode) illumination.

FIG. 9. Measured and simulated focal diameter, outermost Fresnel ring width, and diameter of ejected droplets versus the number of the actuated rings from the center.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

The term “electrical signal” refers to the electrical output from an electronic device or the electrical input to an electronic device. The electrical signal is characterized by voltage and/or current. The electrical signal can be stationary with respect to time (e.g., a DC signal) or it can vary with respect to time.

The terms “DC signal” refer to electrical signals that do not materially vary with time over a predefined time interval. In this regard, the signal is DC over the predefined interval. “DC signal” includes DC outputs from electrical devices and DC inputs to devices.

The terms “AC signal” refer to electrical signals that vary with time over the predefined time interval set forth above for the DC signal. In this regard, the signal is AC over the predefined interval. “AC signal” includes AC outputs from electrical devices and AC inputs to devices.

Throughout this application, where publications are referenced, the disclosures of these publications in their entireties are hereby incorporated by reference into this application to more fully describe the state of the art to which this invention pertains.

Abbreviations:

“PZT” means lead zirconate titanate.

“SFAT” means self-focusing acoustic transducer.

“Vₚₚ” means peak-to-peak AC voltage.

“RIE” means reactive ion etching.

“LED” means light-emitting diode.

“PRF” means pulse repetition frequency.

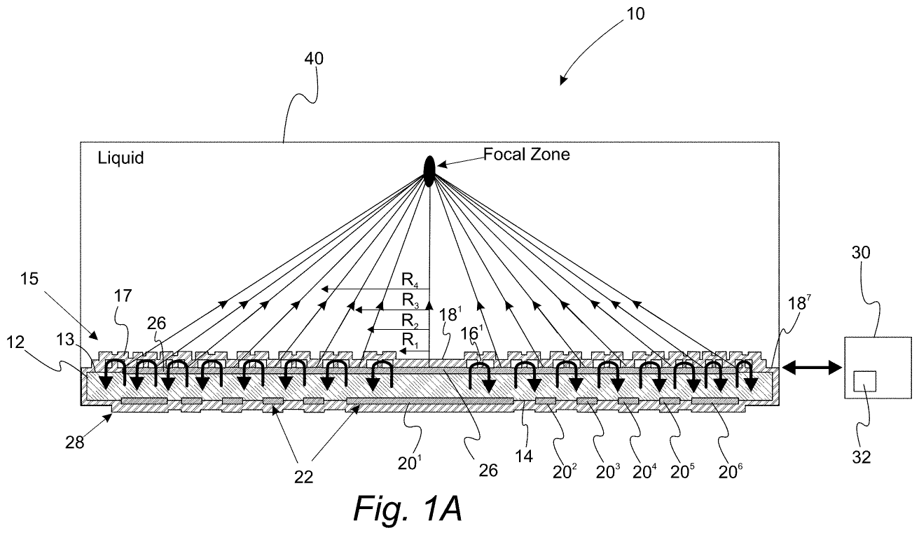

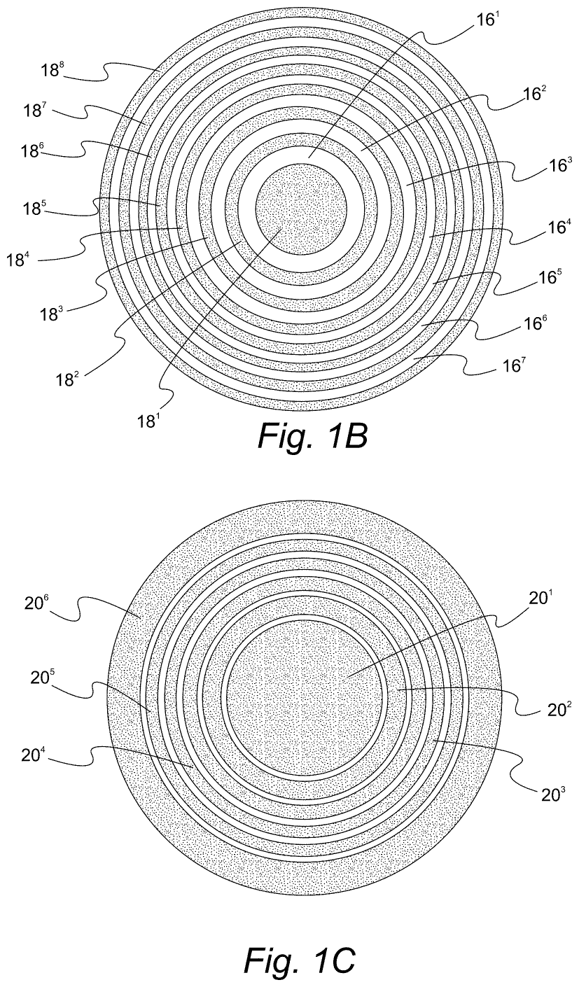

With reference to FIGS. 1A, 1B, and 1C, schematic illustrations of a focused ultrasonic transducer are provided. The focused ultrasonic transducer 10 includes a piezoelectric substrate 12 having a top face 13 and a bottom face 14. In a refinement, the piezoelectric substrate can be composed of lead zirconate titanate, zinc oxide, aluminum nitride, aluminum scandium nitride, lithium niobite, lead magnesium niobate-lead titanate. A particular example of a useful piezoelectric substrate is lead zirconate titanate. Typically, the piezoelectric substrate has an ultrasonic fundamental thickness-mode resonant frequency (e.g., from about 0.5 to 900 MHz). In a refinement, the piezoelectric substrate 12 has a thickness from about 2 μm to about 10 mm or more.

Fresnel acoustic lens 15 includes a plurality of annular rings 16′ of air cavities disposed on the top face 13 where i is an integer label for each annular ring having air cavities. The air cavities are typically formed in (i.e., defined by) a polymer such as Parylene. Therefore, polymer layer 17 is diposed over on the top face 13. Polymer layer 17 defines the annular rings 16′ of air cavities. In a refinement, focused ultrasonic transducer 10 includes from 3 to 128 annular rings having air cavities. Advantageously, the plurality of annular rings 16′ of air cavities block acoustic waves. A plurality of annular rings 18^{k} that do not have air cavities are also disposed over the top face 13 where k is an integer label for these rings. In a refinement, the plurality of annular rings 18^{k} that do not have air cavities is also defined by polymer layer 17.

Plurality of patterned annular ring electrodes 20ⁱ are disposed on the bottom face where j is an integer label for each annular ring electrode. In a refinement, focused ultrasonic transducer 10 includes from 3 to 128 annular ring electrodes. In a further refinement, the number of annular electrode rings is chosen to be equal to or less than that of annular air-cavity-lens rings.

FIG. 1B provides a top view of focused ultrasonic transducer 10 having 7 annular rings 16¹-16⁷ of air cavities. FIG. 1B also illustrates that focused ultrasonic transducer 10 includes a plurality of annular rings 18¹-18⁸ that do not have air cavities. In this context, central disk 18′ is regarded as an annular ring that does not have air cavities.

In the variation, plurality of patterned annular ring electrodes 20 is formed from a first metal layer 22 which is disposed over the bottom face 14 of piezoelectric substrate 12. The first metal layer is a patterned metal layer having a central circular electrode 20¹ surrounded by the plurality of patterned annular ring electrodes 20²-20^{m} where m is the total number of patterned annular ring electrodes. In this context, the central circular electrode 20¹ is considered an annular ring electrode. Collectively, characteristically, each of the central circular electrode and the plurality of patterned annular ring electrodes are wired to be individually accessible. In a refinement, a second metal layer 26 is disposed over the top face and functions as a top electrode. The second metal layer has a sufficient area to extend over regions of the top face 13 that are opposite to regions of the bottom face 14 over which the first metal layer 22 of annular ring electrodes are disposed. In a further refinement, the plurality of annular rings of air cavities 16′ and the plurality of annular rings 18¹-18⁸ that do not have air cavities are disposed over and optionally contact the second metal layer 26. Characteristically, the plurality of annular rings of air cavities is patterned into Fresnel half-wavelength annular rings. In yet another further refinement, each annular ring electrode 20^{j} overlaps at least one annular ring of an air cavity and therefore is corresponding thereto. In still another further refinement, widths of annular ring electrodes 20^{j} are slightly wider than corresponding Fresnel ring widths for the air cavities. FIG. 1C provides a bottom view of focused ultrasonic transducer 10 having 6 annular ring electrodes 20¹-20⁶.

In a variation, polymer layer 17 is part of a polymeric encapulant 28 surrounds the piezoelectric substrate 12, the first metal layer 22, and the second metal layer 26 as depicted in FIG. 1A.

In a variation, focused ultrasonic transducer 10 further includes controller 30 that actuates a subset of the central circular electrode and the plurality of patterned annular ring electrodes such that electrical control of focal size is achieved by selecting a group of the electrodes to be actuated so that acoustic waves generated from the selected electrodes arrive at a desired focal length in-phase and interfere constructively to create a focal spot of high acoustic intensity. In this regard, a total number of the first metal electrodes on the top face can provide a bit resolution for controlling precision. Therefore, the plurality of the patterned annular ring electrodes can include from 3 to 128 concentric ring electrodes. As set forth above, the plurality of patterned annular ring electrodes (i.e., the bottom electrodes) and the top electrode are wired to be individually accessible. In a refinement, wires soldered from the front electrode and bottom electrode rings of the transducer are connected to a circuit board 32 with switches to selectively actuate individual electrode rings. Triggered by a pulse generator, a function generator (such as aTektronix AFG 3252) generates a train of sinusoidal pulses of 2.32 MHz, which is then amplified by a power amplifier (such as Amplifier Research 75A250) and applied onto the circuit board to drive the device. The voltage amplitude can typically vary from 10 to 500 Vₚₚ.

Collectively, the plurality of annular rings 16ⁱ of air cavities blocks acoustic waves and can be referred to as Fresnel rings. Therefore, when numbering from the center with integer label n, odd labeled Fresnel rings are the annular rings 18^{k} that do not have air cavities while even labeled Fresnel rings are the annular rings 16ⁱ of air cavities. Formula (1) set forth below can be used to calculate the radius Rₙ of the n^{th} Fresnel ring boundary where A is the wavelength of a generated ultrasonic wave in a medium in which the generated ultrasonic wave is propagating, n is a label for a Fresnel ring boundary, and F is a predetermined focal length. In a refinement, the radius the radius Rₙ to the outer edge of the n^{th} Fresnel ring as determined from the center of the first annular ring 18¹ that does not have air cavities.

In another embodiment, a method of ejecting droplets from a liquid is provided. Referring to FIG. 1A, focused ultrasonic transducer 10 is used to focus an ultrasonic wave (i.e., ultrasonic energy) at a focal zone at or near a liquid surface 40. In a refinement, the focal zone is within 20 mm of the liquid surface to eject one or more droplets. In another refinement, the focal zone is within 10 mm of the liquid surface. In still another refinement, the focal zone is within 2 mm of the liquid surface.

Additional details of the present invention are found in Y. Tang and E. S. Kim, “Electrical Tuning of Focal Size with Single Focused Ultrasonic Transducer,” 2018 IEEE International Ultrasonics Symposium (IUS), Kobe, Japan, October 2018, pp. 1-4, doi: 10.1109/ULTSYM.2018.8579883, the entire disclosures of these documents are hereby incorporated by reference in their entireties.

The following examples illustrate the various embodiments of the present invention. Those skilled in the art will recognize many variations that are within the spirit of the present invention and scope of the claims.

Device Design

Generation of Focused Ultrasound

The modified SFAT (FIG. 1A) is built on a 1-mm-thick PZT sheet, whose fundamental thickness-mode resonant frequency is 2.32 MHz. On the top side of the PZT, we pattern the nickel electrode into a circle, on top of which are 8 annular-ring air cavities formed with and sealed in Parylene (white annular-ring areas in FIG. 1B), while other areas are uniformly coated with Parylene with no air cavities. The radii of the annular rings are designed into Fresnel half-wavelength bands (FHWB) rings for 6 mm focal length, so that the difference in acoustic path lengths from two boundaries of a Fresnel band to the focal point (6 mm above transducer center) equals half wavelength. The radius of the n^{th} Fresnel ring boundary (FIG. 1A) is given by [6]:

$${R}_{n} = \sqrt{n λ \times ( F + \frac{n λ}{4} )} \qquad ( 1 )$$

in which λ is the wavelength in the medium (water), and F is the designed focal length (6 mm). This way, acoustic waves coming from odd Fresnel rings (areas where Rₙ<R<Rₙ₊₁, n=0, 2, 4, . . . ) will interfere constructively while those from even rings (Rₙ<R<Rₙ₊₁, n=1, 3, 5, . . . ) will lead to destructive interference.

The air-cavity reflector lens covers all even Fresnel rings, so that due to acoustic impedance mismatch between air (only 0.4 kRayl) and solid/liquid (over 1 MRayl), acoustic waves which contribute to destructive interference will be reflected back by the air-cavity rings, while the waves in the non-air-cavity areas (odd Fresnel ring areas) propagate through Parylene layer of the lens (which is used for electrical insulation and acoustic matching), and interfere constructively at the focal point, producing focused ultrasound with high acoustic intensity.

Electrical Tuning of Focal Size

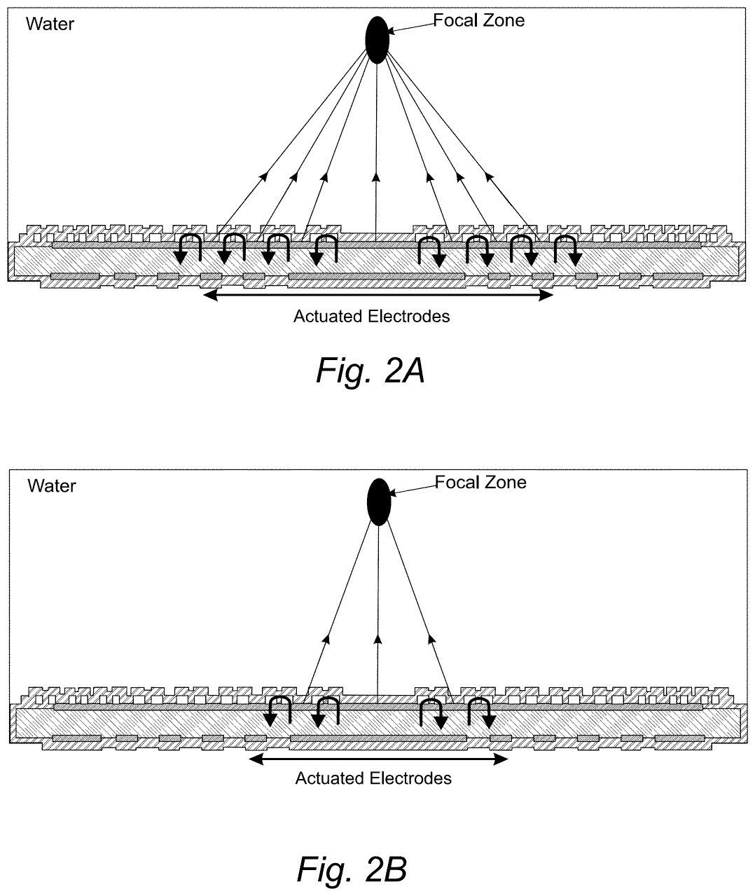

On the PZT's bottom side (FIG. 1C), the nickel electrode is patterned into 6 annular rings overlapping with the first two, the third, the fourth, the fifth, the sixth, and the last two (of the 8 Fresnel rings) on the top, so that we may electrically select any combination of the 6 electrode rings to produce acoustic waves (on corresponding annular regions) that will pass through the air-cavity lens for focusing (FIG. 2). The bottom electrode ring width are designed to be slightly wider than its corresponding top Fresnel ring width, so that small errors in top-bottom alignment during fabrication would not affect device operation. The corresponding relationship between top Fresnel rings and bottom electrode rings, as well as the radii of all Fresnel rings are shown in Table I. The number of annular electrode rings is chosen to be less than that of annular air-cavity-lens rings, in order to ensure (1) enough focusing when the smallest number of the electrodes is chosen and (2) enough width on the outermost electrode (which is the narrowest among all the patterned electrodes) for wire connection.

TABLE I
Corresponding Relationship Between Top Fresnel Rings and Bottom Electode
Rings, with Inner and Outer Radii of Each Fresnel Rings

| Ring Type | Ring Sequence | | | | | | | |
|---|---|---|---|---|---|---|---|---|
| Top Fresnel Rings | 1st | 2nd | 3rd | 4th | 5th | 6th | 7th | 8th |

| | | | | | | |
|---|---|---|---|---|---|---|
| Bottom Electrode Rings | 1st | 2nd | 3rd | 4th | 5th | 6th |

Boundary Radii of Top Fresnel Rings (Inner, Outer in mm)

| 1st | 2nd | 3rd | 4th |
|---|---|---|---|
| 0.000, 1.982 | 2.839, 3.521 | 4.116, 4.656 | 5.160, 5.637 |
| 5th | 6th | 7th | 8th |
| 6.094, 6.534 | 6.961, 7.377 | 7.783, 8.183 | 8.575, 8.961 |

According to Fresnel zone plate theory, the focal size of a Fresnel lens is close to the width of its outermost ring band (if its boundary radii are much larger than its width) [7], which decreases as the ring order gets higher. This suggests that, as the number of Fresnel rings being actuated from the center increases, the width of the outermost ring decreases, and consequently, the focal size becomes smaller (due to better focusing effect), as shown in FIG. 2. Although the output acoustic intensity will vary when the number of actuated rings changes, this could be compensated by adjusting the voltage applied on the device.

Fabrication

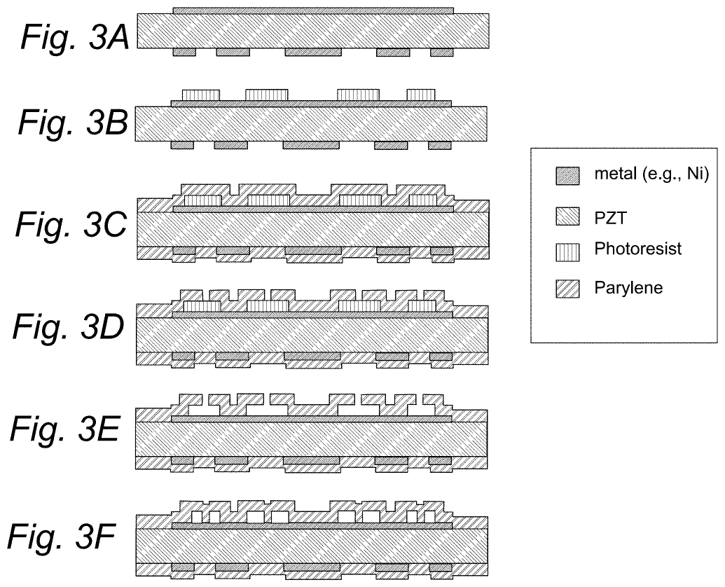

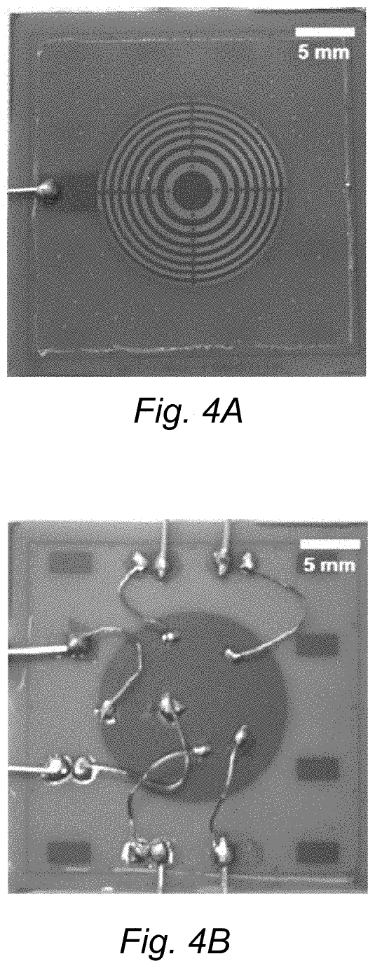

The fabrication process of the transducer [5] is briefly illustrated in FIG. 3. First, front and back nickel electrodes on a 1-mm-thick PZT-5A sheet are patterned through photolithography and wet etching (FIG. 3A). For front-to-backside alignment, we align one corner of the PZT sheet to a reference corner on the masks for patterning of top and bottom electrodes. Then AZ 5214 photoresist is spin-coated at 1,200 rpm to form a sacrificial layer for air cavities with a thickness of around 3.5 μm, and is patterned into Fresnel half-wavelength annular rings (FIG. 3B). After that, 4 μm thick Parylene D is deposited (FIG. 3C), followed by the patterning of “release holes” on Parylene through O₂ reactive ion etching (RIE) to expose the photoresist sacrificial layer (FIG. 3D), which is then removed by soaking the substrate in acetone (FIG. 3E), as the acetone dissolves the photoresist sacrificial layer through the release holes. After rinsing with methanol, isopropyl alcohol (IPA) and DI water, in that order, followed by air drying, we deposit 12.5 μm thick Parylene D to fill and seal the open holes (FIG. 3F). After fabrication, wires are soldered on the front electrode (FIG. 4A) and bottom electrode rings (FIG. 4B), then connected to a circuit board with switches to realize individual actuation of electrode rings.

Experiments and Results

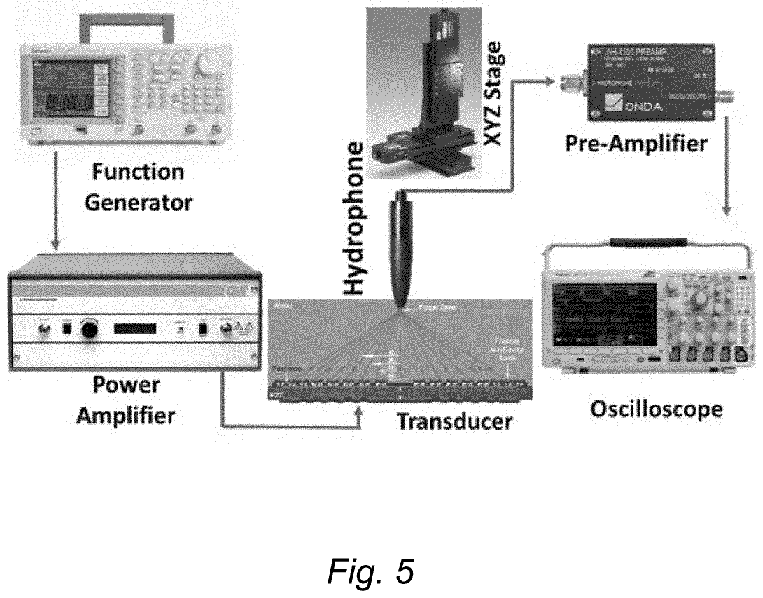

To experimentally determine the focal size, first, a vertical scan of acoustic pressure along the center line was done to find the focal length with a commercial hydrophone (Onda HGL-0085) fixed onto a motorized 3-axis stage, and then a lateral scan of acoustic pressure along a central lateral axis was done at the focal plane with the same setup (FIG. 5). During measurement, the top electrode and the inactivated bottom electrodes were connected to ground, while the actuated bottom electrodes were connected to driving signal. The transducer was driven with 2.32 MHz pulsed sinusoidal signal with a pulse width of 6.03 μs and the voltage level was adjusted in each case to keep the maximal intensity level the same, as we varied the number of the actuated electrode rings from the center.

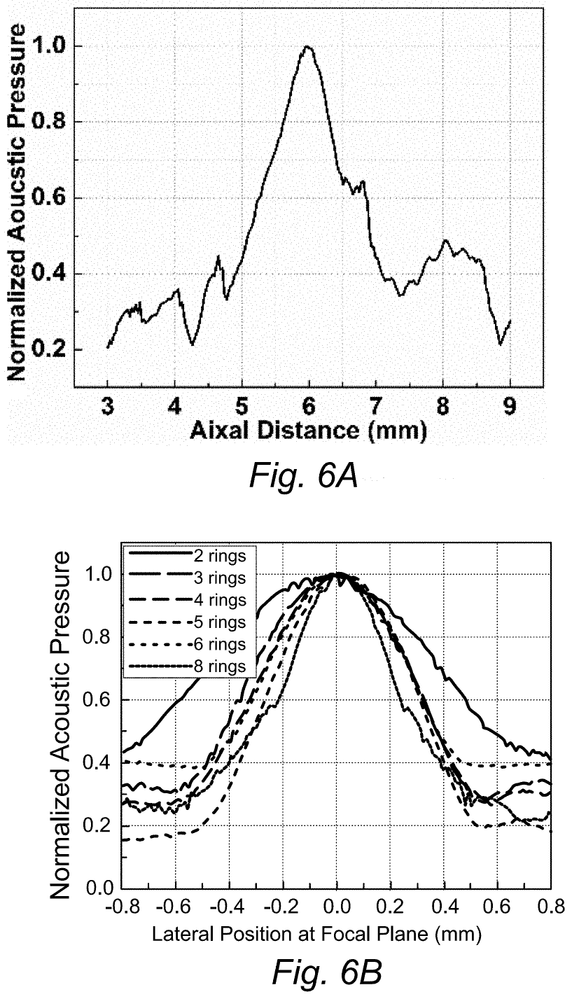

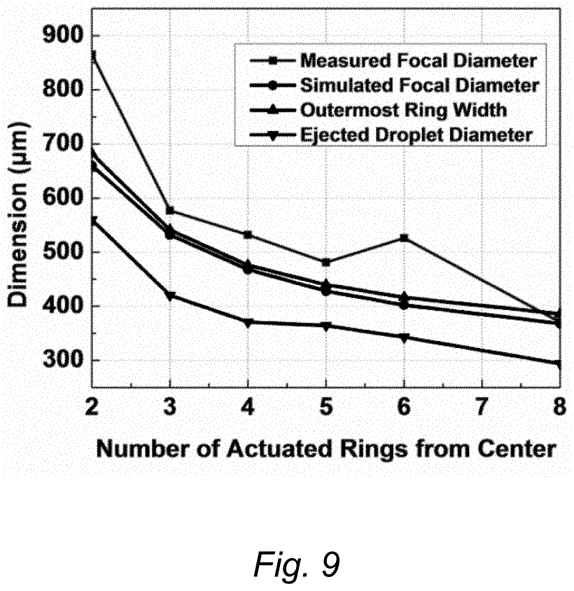

From the result of vertical scan (FIG. 6A), we have confirmed that the focal length is 6 mm. And by controlling the number of Fresnel rings being driven from the center, the beam profiles in the focal plane were varied (FIG. 6B), from which the −3 dB focal diameter was calculated. The measurement and simulation (as well as outmost ring width estimation of the focal sizes) of focal diameter are in good agreement over a wide range (371-866 μm) of the focal size (FIG. 9). The slight deviation from theory might be due to fringing fields between adjacent electrode rings and non-thickness vibration modes (since electrode width is comparable to or less than the PZT thickness), which were not considered in simulation or calculation.

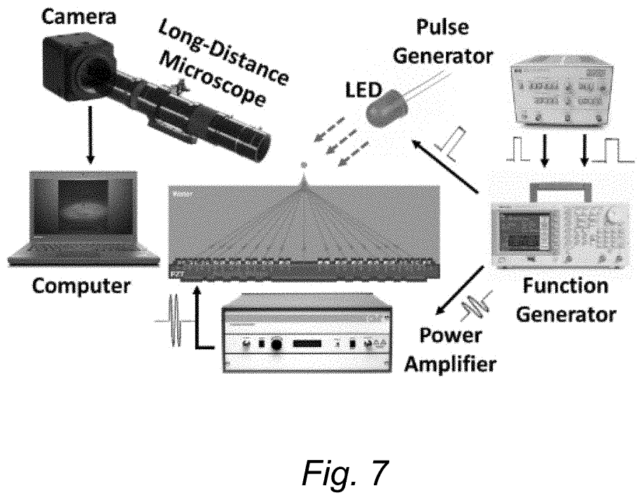

The transducer has been tested as a droplet ejector capable of ejecting sub-mm-sized droplets, whose dimension could be electrically controlled. During the tests, the transducer placed in a beaker filled with water was driven with 2.32 MHz pulsed sinusoidal signals of 200 Vₚₚ (for driving 5, 6, and 8 Fresnel rings from center) or 250 Vₚₚ (for driving 2, 3, and 4 Fresnel rings from center), at a pulse repetition frequency (PRF) of 10 Hz. Triggered by a pulse generator, a function generator generates a train of sinusoidal pulses, which is then amplified by a power amplifier to drive the device, producing focused ultrasound whose intensity is high enough to overcome surface tension and eject droplets when water surface is at the focal plane. A red light-emitting diode (LED) driven by another channel of the function generator (also triggered by the pulse generator) served as a light source to stroboscopically observe the ejection process with a certain delay after device actuation (FIG. 7). A camera whose frame rate was set to be the same as PRF (10 Hz) was attached at the end of a long-range microscope focused on the water surface where ejection happens. The camera was connected to a computer to capture the ejection process.

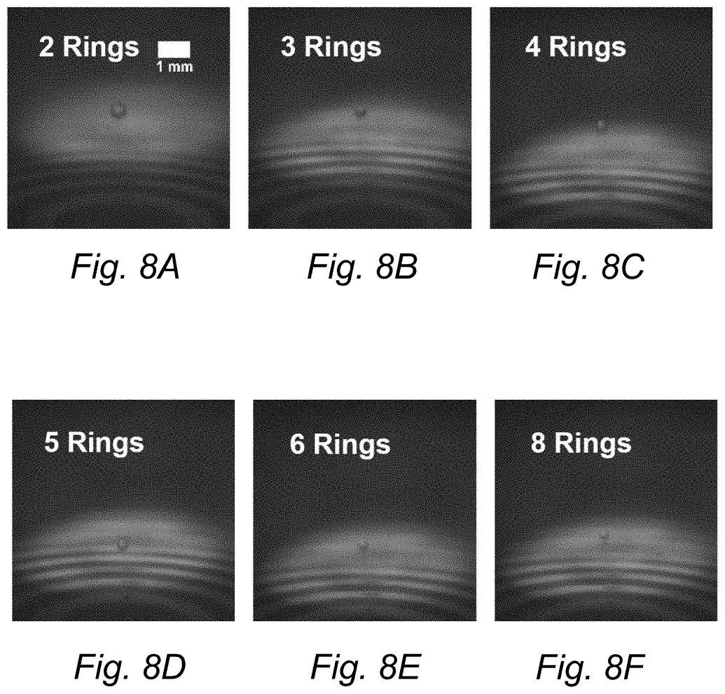

We were able to observe ejection of single water droplet per pulse in all cases when we actuated two, three, four, five, six, and eight Fresnel rings from center (FIG. 8), with droplet diameter ranging from 294 to 560 μm, which corresponds to volumes from 13.3 nL to 92.0 nL. The droplet diameter follows the trend of the focal size when different number of rings are actuated (FIG. 9), and the diameter and volume of the largest droplets are about 2.0 and 7.6 times larger than our previously reported values in [2]. During an operation of 5 min, no temperature rise was detected.

### CONCLUSIONS

Aspects of the focused ultrasonic transducer advantageously provide:

(1) Single-element planar focused ultrasonic transducer comprising a piezoelectric substrate that is sandwiched with top and bottom electrode, one or both of which are patterned into Fresnel annular rings for focusing and also can individually be selected for electrical tuning of the focal size;

(2) Single-element planar focused ultrasonic transducer comprising a piezoelectric substrate with patterned electrodes plus Fresnel air-cavity rings (on the top of the transducer electrode) that focus the ultrasounds produced by the piezoelectric substrate upon electrical signal applied to the electrodes;

(3) Plurality of patterned annular-ring electrodes (for selecting the number of Fresnel rings being actuated from center) on the bottom or top of a piezoelectric substrate, with the number being 3-128, which allows electrical tuning of the focal size into 126 different values;

(4) The concept of decreasing the applied voltage when the number of the actuated electrodes is increased (or vice versa), in order to maintain the same acoustic intensity at the focal point.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

[1] Y. Choe, J. W. Kim, K. K. Shung, and E. S. Kim, “Microparticle trapping in an ultrasonic Bessel beam,” Applied Physics Letters, vol. 99, no. 23, p. 233704, 2011.
[2] Y. Tang, L. Wang, Y. Wang and E. S. Kim, “On-demand, heatless ejection of sub-millimeter-sized liquid droplets,” The 30th IEEE International Conference on Micro Electro Mechanical Systems (MEMS 2017), Las Vegas, Nev., Jan. 22-26, 2017, pp. 1196-1199.
[3] S.-S. Yoo, A. Bystritsky, J.-H. Lee, Y. Zhang, K. Fischer, B.-K. Min, N. J. Mcdannold, A. Pascual-Leone, and F. A. Jolesz, “Focused ultrasound modulates region-specific brain activity,” NeuroImage, vol. 56, no. 3, pp. 1267-1275, 2011.

[4] L. Wang, Y.-J. Li, A. Lin, Y. Choe, M. E. Gross, and E. S. Kim, “A self-focusing acoustic transducer that exploits cytoskeletal differences for selective cytolysis of cancer cells,” IEEE/ASME Journal of Microelectromechanical Systems, vol. 22, no. 3, pp. 542-552, 2013.

[5] C.-Y. Lee, H. Yu and E. S. Kim, “Acoustic ejector with novel lens employing air-reflectors,”, The 19th IEEE International Micro Electro Mechanical Systems Conference (MEMS 2006), Istanbul, Turkey, Jan. 22-26, 2006, pp. 170-173.

[6] J. C. Wiltse, “The Fresnel zone-plate lens,” in Proceedings of the SPIE, October 1985, vol. 0544.

[7] H. H. Barrett and F. A. Horrigan, “Fresnel zone plate imaging of gamma rays: Theory,” Applied Optics, vol. 12, no. 11, p. 2686, 1973.

What is claimed is:

1. A focused ultrasonic transducer comprising:
a piezoelectric substrate having a top face and a bottom face;
a Fresnel acoustic lens including a plurality of annular rings of air cavities disposed on the top face; and
a plurality of patterned annular ring electrodes on the bottom face.

2. The focused ultrasonic transducer of claim 1, wherein
a first metal layer disposed over the bottom face, the first metal layer being a patterned metal layer having a central circular electrode surrounded by the plurality of patterned annular ring electrodes wherein each of the central circular electrode and the plurality of patterned annular ring electrodes are wired to be individually accessible; and
a second metal layer disposed over the top face, the second metal layer having a sufficient area to extend over regions of the top face that are opposite to regions of the bottom face over which annular ring electrodes are disposed; and
the plurality of annular rings of air cavities is disposed over the second metal layer, the plurality of annular rings of air cavities being patterned into Fresnel half-wavelength annular rings.

3. The focused ultrasonic transducer of claim 2, further comprising a controller that actuates a subset of the central circular electrode and the plurality of patterned annular ring electrodes such that electrical control of focal size is achieved by selecting a group of electrodes to be actuated so that acoustic waves generated from selected electrodes arrive at a desired focal length in-phase and interfere constructively to create a focal spot of high acoustic intensity.

4. The focused ultrasonic transducer of claim 1, wherein each annular ring electrode overlaps at least one ring of an air cavity.

5. The focused ultrasonic transducer of claim 1, wherein widths of annular ring electrodes are slightly wider than corresponding Fresnel air-cavity-ring widths.

6. The focused ultrasonic transducer of claim 1, wherein number of annular electrode rings is chosen to be less than that of annular air-cavity-lens rings.

7. The focused ultrasonic transducer of claim 1, wherein the piezoelectric substrate comprises lead zirconate titanate, zinc oxide, aluminum nitride, aluminum scandium nitride, lithium niobite, lead magnesium niobate-lead titanate.

8. The focused ultrasonic transducer of claim 1, wherein the piezoelectric substrate has an ultrasonic fundamental thickness-mode resonant frequency.

9. The focused ultrasonic transducer of claim 1, wherein the piezoelectric substrate has a fundamental thickness-mode resonant frequency from about 0.5 to 900 MHz.

10. The focused ultrasonic transducer of claim 1, wherein a total number of electrodes on the bottom face provides a bit resolution for controlling precision.

11. The focused ultrasonic transducer of claim 1, wherein the plurality of patterned annular ring electrodes includes from 3 to 128 concentric ring electrodes.

12. The focused ultrasonic transducer of claim 1, the Fresnel acoustic lens further includes a plurality of annular rings that do not have air cavities, the plurality of annular rings that do not have air cavities alternating with the plurality of annular rings of air cavities on the top face.

13. The focused ultrasonic transducer of claim 12, wherein collectively, the plurality of annular rings that do not have air cavities and the plurality of annular rings of air cavities are Fresnel rings.

14. The focused ultrasonic transducer of claim 13, wherein a radius of an n^{th} Fresnel ring boundary is given by:
$${R}_{n} = \sqrt{n λ \times ( F + \frac{n λ}{4} )} \qquad ( 1 )$$
where λ is the wavelength of a generated ultrasonic wave in a medium in which the generated ultrasonic wave is propagating, n is a label for a Fresnel ring boundary, and F is a predetermined focal length.

15. A method of ejecting droplets from a liquid, the method comprising:
a) providing a focused ultrasonic transducer including:
a piezoelectric substrate having a top face and a bottom face;
a Fresnel acoustic lens including a plurality of annular rings of air cavities disposed on the top face; and
a plurality of patterned annular ring electrodes on the bottom face, top face, or top and bottom faces; and
b) focusing an ultrasonic wave at a focal zone at or near a liquid surface to eject one or more droplets.

16. The method of claim 15, wherein the focal zone is within 10 mm of the liquid surface.

17. The method of claim 15, wherein the focused ultrasonic transducer includes:
a first metal layer disposed over the bottom face, the first metal layer being a patterned metal layer having a central circular electrode surrounded by the plurality of patterned annular ring electrodes wherein each of the central circular electrode and the plurality of patterned annular ring electrodes are wired to be individually accessible; and
a second metal layer disposed over the top face, the second metal layer having a sufficient area to extend over regions of the top face that are opposite to regions of the bottom face over which annular ring electrodes are disposed; and
the plurality of annular rings of air cavities is disposed over the second metal layer, the plurality of annular rings of air cavities being patterned into Fresnel half-wavelength annular rings.

18. The method of claim 17, wherein the focused ultrasonic transducer further includes a controller that actuates a subset of the central circular electrode and the plurality of patterned annular ring electrodes such that electrical control of focal size is achieved by selecting a group of electrodes to be actuated so that acoustic waves generated from selected electrodes arrive at a desired focal length in-phase and interfere constructively to create a focal spot of high acoustic intensity.

19. The method of claim 15, wherein each annular ring electrode overlaps at least one annular ring having air cavity.

20. The method of claim 15, wherein widths of annular ring electrodes are slightly wider than corresponding Fresnel air-cavity-ring widths.
